(19) United States
(12) Patent Application Publication
(10) Pub. No.: US 2007/0194784 A1
(43) Pub. Date: Aug. 23, 2007

(54) Non-contacting magnetic position sensor, and method of determining the position between two relatively-movable members

(75) Inventor: Richard J. Perini, Holland, NY (US)

Correspondence Address: PHILLIPS LYTLE LLP;INTELLECTUAL PROPERTY GROUP, 3400 HSBC CENTER, BUFFALO, NY, 14203-3509, US

(73) Assignee: Moog Inc.

(21) Appl. No.: 11/359,111

(22) Filed: Feb. 22, 2006

(51) Int. Cl. G01B 7/14

(52) U.S. Cl. 324/207.24

(57) ABSTRACT

A non-contacting position sensor (20) for sensing and determining the position between two relatively-movable members (23, 31) includes a pair of flux-conductive converging polepieces (21, 22) mounted on one of the members (23); a magnetic sensor (29) mounted on the one member and positioned proximate the convergent polepiece ends, this magnetic sensor being adapted to produce an output signal as a function of the magnetic flux density therein; and a magnet (30) mounted on the other member (31) for movement toward and away from the magnetic sensor, this magnet being positioned between the polepieces to define the first air gap between the magnet and one polepiece and a second air gap between the magnet and the other polepiece, the reluctances (RV1, RV2) of the first and second air gaps (32, 33, respectively) varying as a function of the position of the magnet relative to the magnetic sensor such that the sensor output signal will be a function of the position of the magnet from the magnetic sensor.

### TECHNICAL FIELD

The present invention relates generally to position sensors and methods of determining the positions between two relatively-movable members, and, more particularly, to an improved non-contacting magnetically-operated position sensor for sensing and determining the position between two relatively-movable members, and to an improved method of determining the position between such members.

### BACKGROUND ART

There are many applications in which it is necessary to determine the position between two relatively-movable members.

In some applications, it would be highly desirable to determine such position without introducing friction between the members.

In still other applications, it would be desirable to provide such a position detector that is relatively insensitive to vibrations and the like.

### DISCLOSURE OF THE INVENTION

With parenthetical reference to the corresponding parts, portions or surfaces of the disclosed embodiment, merely for purposes of illustration and not by way of limitation, the present invention broadly provides an improved non-contacting magnetically-operated position sensor for sensing and determining the position between two relatively-movable members, and to an improved method of determining the position between two relatively-movable members.

The improved position sensor (20) broadly comprises: a pair of flux-conductive converging polepieces (21, 22) mounted on one of the members (23), the polepieces having convergent ends (24, 25) and divergent ends (26, 28); a magnetic sensor (29) mounted on the one member and positioned proximate one of the ends of the polepieces, the magnetic sensor being adapted to produce an output signal as a function of the magnetic flux density therein; and a magnet (30) mounted on the other of the members for movement toward and away from the magnetic sensor, the magnet being positioned between the polepieces to define a first air gap (32) between the magnet and a first of the polepieces and a second air gap (33) between the magnet and a second of the polepieces; the reluctances (RV1 and RV2, respectively) of the first and second air gaps (32, 33, respectively) varying as a function of the position of the magnet relative to the magnetic sensor; whereby the sensor output signal will be a function of the position of the magnet from the magnetic sensor, which causes the lengths of air gaps RV1 and RV2 to change.

The sum of the reluctances of the first and second air gaps is a constant at any position of the magnet relative to the magnetic sensor.

In one form, the polepieces are positioned symmetrically about an axis (x-x), and the magnet moves substantially along the axis. Hence, the reluctances of the first and second air gaps are substantially equal at all permitted positions of the magnet relative to the magnetic sensor.

The magnet may be mounted for linear or rotary movement relative to the magnetic sensor. If mounted for rotary movement, the polepieces may be helically wound on the one member.

The magnetic sensor may be a Hall effect sensor, a magneto-resistive sensor, or some other sensor.

In one form, the transverse cross-section of each polepiece is substantially constant along its entire operative length, and may be substantially rectangular. In another form, the transverse cross-sections of the polepieces are shaped along their lengths such that the magnetic sensor output signal varies substantially linearly with the position of the magnet from the magnetic sensor.

The magnet and the first and second air gaps may be arranged magnetically in series with the magnetic sensor. The magnet may be formed of a rare earth material, or any high coercive force magnet material.

The position sensor may further include: a first stop (34) for limiting movement of the magnet toward the magnetic sensor, and a second stop (35) for limiting movement of the magnet away from the magnetic sensor.

The magnetic sensor (29) is preferably positioned between the convergent ends (24, 25) of the polepieces.

The improved method broadly includes the steps of: mounting a magnet (30) on one of the members (31); mounting a magnetic sensor (29) on the other of the members (23), the magnetic sensor being adapted to produce an output signal as a function of the magnetic flux density therein; mounting a flux-conductive first polepiece (21) on the other member (23) so as to define a first air gap (32) between the magnet and the first polepiece, the length of the first air gap varying with the distance between the magnet and the magnetic sensor; and mounting a flux-conductive second polepiece (22) on the other member so as to define a second air gap (33) between the magnet and the second pole-piece, the length of the second air gap varying with the distance between the magnet and the magnetic sensor; thereby to provide a magnetic circuit in which the magnet, the magnetic sensor and the air gaps are arranged in series such that the output signal of the magnetic sensor will be a function of the distance between the magnet and the magnetic sensor, which causes the variable-reluctance air gaps (RV1 and RV2) to change.

With this method, the polepieces may be so configured and arranged that the output signal varies substantially linearly with the distance between the magnet and the magnetic sensor.

Accordingly, the general object of this invention is to provide an improved non-contacting position sensor for sensing and determining the position of two relatively-movable members.

Another object is to provide and improved method of determining the position between two relatively-movable members.

These and other objects and advantages will become apparent from the foregoing an ongoing written specification, the drawings and the appended claims.

### BRIEF DESCRIPTION OF THE DRAWINGS

FIG. 1 is a schematic view of an improved non-contacting magnetically-sensitive position sensor.

FIG. 2 is a magnetic circuit of the structure schematically shown in FIG. 1.

FIG. 3 is a curve of sensor output signal (volts) versus relative position (degrees).

### DISCLOSURE OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

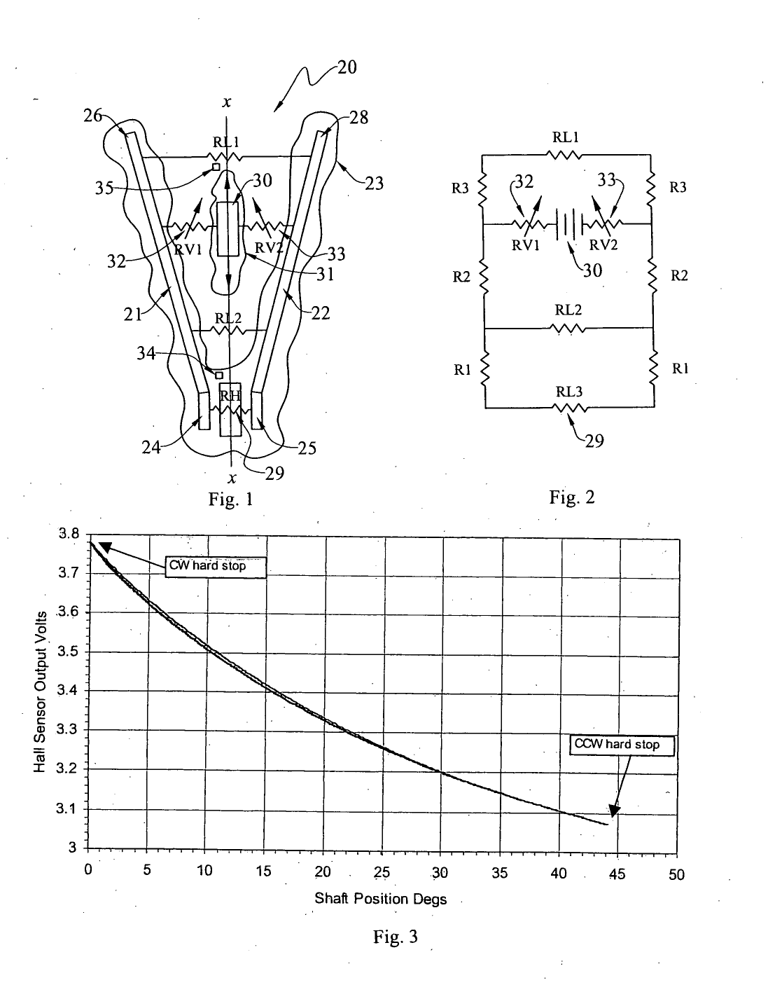

Referring now to the drawings, and, more particularly, to FIG. 1 thereof, the improved non-contacting position sensor is generally indicated at 20. The position sensor broadly includes a pair of flux-conductive converging polepieces 21, 22 mounted on one member, a portion of which is indicated at 23. The polepieces have lower convergent marginal end portions 24, 25, and upper divergent marginal end portions 26, 28.

A magnetic sensor 29, such as a Hall effect sensor, a magneto-resistive sensor or the like, is mounted on member 23 and is adapted to produce an output signal as a function of the magnetic flux density therein.

A magnet 30 is mounted on another member 31 that is movable relative to member 30. In FIG. 1, the magnet is movable in the direction of the arrows along axis x-x both toward and away from the magnetic sensor. Thus, the magnet is positioned between the polepieces to define a first air gap 32 between the magnet and left polepiece 21, and a second air gap 33 between the magnet and right polepiece 22. The reluctances of these two air gaps (RV1 and RV2, respectively) vary with their respective lengths, as a function of the position of the magnet along axis x-x relative to the magnetic sensor. Hence, the sensor output signal will be a function of the position of the magnet from the magnetic sensor, since air gaps RV1 and RV2 change with this position.

The sum of the reluctances of the first and second air gaps is a constant at any position of the magnet relative to the motor, regardless of whether the magnet is generally centered between the polepieces or not. If axis x-x bisects the angle of convergence of the polepieces, then the sum of the reluctances of the first and second air gaps 32, 33 will be substantially the same, assuming that each polepiece has a constant transverse cross-section and composition.

FIG. 1 may be thought of as being a linear embodiment. However, the magnet could be on one member that is mounted for rotation relative to the polepieces. Hence, the improved sensor may be implemented in either a linear manner or a rotary manner, as desired. The position sensor may further include a first stop, indicated at 34, for limiting movement of the magnet in a direction toward the magnetic sensor, and has another complimentary stop 35 for limiting movement of the magnet away from the sensor.

In another aspect, the invention provides an improved method of determining the position between two relatively-movable members 23, 31, which comprises the steps of: mounting the magnet 30 on one of the members 31; mounting a magnetic sensor 29 on the other of the members 23, the magnetic sensor being adapted to produce an output signal as a function of the magnetic flux density therein; mounting a flux-conductive first polepiece 21 on the other member 23 so as to define a first air gap 32 between the magnet and the first polepiece, the length of the first air gap varying with the distance between the magnet and the magnetic sensor; and mounting the flux-conductive second polepiece 22 on the other member so as to define a second air gap 33 between the magnet and the second polepiece, the length of this second air gap varying with the distance between the magnet and the magnetic sensor; thereby to provide a magnetic circuit in which the magnet, the magnetic sensor and the air gaps are arranged in series such that the output signal of the magnetic sensor will be a function of the distance between the magnet and the magnetic sensor.

FIG. 2 is a magnetic circuit of the structure shown in FIG. 1. The various air gaps and resistances are shown as being resistors. Thus, the magnetic sensor 29 is depicted as having a reluctance RL3, and the leakages between the two polepieces are reflected by reluctances RL1 and RL2, respectively. The magnet 30 is represented as being a battery, and the first and second air gaps are shown as having variable reluctances RV1 and RV2, respectively. Each polepiece is shown as having three reluctances, R1, R2 and R3, respectively, along its longitudinal extent. Thus, the magnet and the two variable reluctances are arranged magnetically in series with the Hall effect sensor. The other reluctances represent leakages and internal reluctances of various pieces and components of the system.

FIG. 3 is a plot of magnetic sensor output signal (ordinate, expressed in volts) versus relative shaft position (abscissa, expressed in terms of shaft position) between the first and second members, for a given magnet, given polepieces and a given magnetic sensor. This version obviously applies to the rotary embodiment disclosed herein. It is seen that the output signal of the magnetic sensor is a function of the relative position between the first and second members, as expressed in relative shaft position, between the two limit stops.

While the curve shown in FIG. 3 is not linear, such curve can be linearized by varying the cross-section of each polepiece along its longitudinal extent. In other words, whereas the polepieces shown in FIG. 1 have a substantially constant rectangular transverse cross-section, this transverse area of this cross-section could possibly increase along the length of each polepiece, as one moved away from the position of the magnetic sensor. By increasing the cross-sectional transverse area of these polepieces, the reluctance would decrease. Hence, by appropriate shaping of the polepieces, the curve shown in FIG. 3 could be linearized such that the magnetic sensor output signal would be a substantially linear function of the relative position between the two relatively-movable members.

The present invention expressly contemplates that many changes and modifications may be made. For example, the particular material of which the polepieces are constructed is not deemed critical, and may be changed. As indicated above, the cross-section of the polepieces may be changed along their longitudinal extents so as to linearize the output signal. The magnetic may be a rare earth material, such as samarium cobalt. However, such magnetic may be of other forms as well. The magnetic sensor may be a Hall effect position sensor, a magneto-resistive element, or some other element responsive to the magnitude of the magnetic flux therein.

Therefore, while a presently-preferred form of the improved position sensor has been shown and described, and several modifications thereof discussed, persons skilled in this art will readily appreciate that various additional changes and modifications may be made without departing from the spirit of the invention, as defined and differentiated by the following claims.

What is claimed is:

1. A non-contacting position sensor for sensing and determining the position between two relatively-movable members, comprising:
a pair of flux-conductive converging polepieces mounted on one of said members, said polepieces having convergent ends and divergent ends;
a magnetic sensor mounted on said one member and positioned proximate one of said polepiece ends, said magnetic sensor being adapted to produce an output signal as a function of the magnetic flux density therein; and
a magnet mounted on the other of said members for movement toward and away from said magnetic sensor, said magnet being positioned between said polepieces to define a first air gap between said magnet and a first of said polepieces and a second air gap between said magnet and a second of said polepieces;
the reluctances of said first and second air gaps varying as a function of the position of said magnet relative to said magnetic sensor;
whereby said sensor output signal will be a function of the position of said magnet from said magnetic sensor.

2. A non-contacting position sensor as set forth in claim 1 wherein the sum of the reluctances of said first and second air gaps is a constant at any position of said magnet relative to said magnetic sensor.

3. A non-contacting position sensor as set forth in claim 1 wherein said polepieces are positioned symmetrically about an axis, and wherein said magnet moves substantially along said axis.

4. A non-contacting position sensor as set forth in claim 3 wherein the reluctances of said first and second air gaps are substantially equal at all permitted positions of said magnet relative to said magnetic sensor.

5. A non-contacting position sensor as set forth in claim 1 wherein said magnet is mounted for linear movement relative to said magnetic sensor.

6. A non-contacting position sensor as set forth in claim 1 wherein said magnet is mounted for rotary movement relative to said magnetic sensor.

7. A non-contacting position sensor as set forth in claim 6 wherein said polepieces are helically wound on said one member.

8. A non-contacting position sensor as set forth in claim 1 wherein said magnetic sensor is a Hall effect sensor.

9. A non-contacting position sensor as set forth in claim 1 wherein said magnetic sensor is a magneto-resistive sensor.

10. A non-contacting position sensor as set forth in claim 1 wherein the transverse cross-section of each polepiece is substantially constant along its length.

11. A non-contacting position sensor as set forth in claim 10 wherein each polepiece has a substantially rectangular transverse cross-section.

12. A non-contacting position sensor as set forth in claim 1 wherein said magnet and said first and second air gaps are arranged magnetically in series with said magnetic sensor.

13. A non-contacting position sensor as set forth in claim 1 wherein said magnet is formed of a rare earth material.

14. A non-contacting position sensor as set forth in claim 1 and further comprising:
a first stop for limiting movement of said magnet toward said magnetic sensor, and
a second stop for limiting movement of said magnet away from said magnetic sensor.

15. A non-contacting position sensor as set forth in claim 1 wherein said magnetic sensor is positioned between the convergent ends of said polepieces.

16. A non-contacting position sensor as set forth in claim 1 wherein the transverse cross-sections of said polepieces are shaped along their lengths such that said magnetic sensor output signal varies substantially linearly with the position of said magnet from said magnetic sensor.

17. The method of determining the position between two relatively-movable members, comprising the steps of:
mounting a magnet on one of said members;
mounting a magnetic sensor on the other of said members, said magnetic sensor being adapted to produce an output signal as a function of the magnetic flux density therein;
mounting a flux-conductive first polepiece on said other member so as to define a first air gap between said magnet and said first polepiece, the length of said first air gap varying with the distance between said magnet and said magnetic sensor; and
mounting a flux-conductive second polepiece on said other member so as to define a second air gap between said magnet and said second polepiece, the length of said second air gap varying with the distance between said magnet and said magnetic sensor;
thereby to provide a magnetic circuit in which said magnet, said magnetic sensor and said air gaps are arranged in series such that the output signal of said magnetic sensor will be a function of the distance between said magnet and said magnetic sensor.

18. The method as set forth in claim 17 wherein said polepieces are so configured and arranged that said output signal varies substantially linearly with the distance between said magnet and said magnetic sensor.
